(19) United States
(12) Patent Application Publication
(10) Pub. No.: US 2010/0242846 A1
(43) Pub. Date: Sep. 30, 2010

(54) Food Dispensers and Aquaculture Systems

(75) Inventors: Sagiv Kolkovski, Mullaloo (AU); John Curnow, Hilton (AU); Justin King, Beaconsfield (AU)

Correspondence Address: KIRK HAHN, 14431 HOLT AVE, SANTA ANA, CA, 92705, US

(73) Assignees: DEPARTMENT OF FISHERIES, PERTH, WA (AU); FISHERIES RESEARCH AND DEVELOPMENT CORPORATION, Darkin West, AC (AU)

(21) Appl. No.: 11/913,197

(22) PCT Filed: May 31, 2006
(86) PCT No.: PCT/AU06/00735

§ 371 Date: Oct. 31, 2007

(30) Foreign Application Priority Data
May 31, 2005 (AU) 2005902784

(51) Int. Cl. A01K 61/02

(52) U.S. Cl. 119/51.04; 222/181.1; 119/51.11; 222/361

(57) ABSTRACT

A food dispenser (10) with particular application to delivering a controlled amount of food material (11) in particulate or powdered form to fish and other aquatic animals, and also a method of delivery of such material. The food dispenser comprises a receptacle (12) for holding the food material and shutter means (14) located at a lower end of the receptacle. In its open position, the shutter provides a passageway (16) from the receptacle past the shutter for delivery of the food material. A dispersing unit (50) supplies an air flow for dispersing the food material. A flexible mounting bracket (60) enables vibration of the dispenser during operation to assist the flow of the food material.

### FIELD OF THE INVENTION

The present invention relates to food dispensers.

The invention has been devised particularly, although not solely, as a food dispenser for delivering a controlled amount of micro-particulate material to aquatic animals in an aquaculture system.

### BACKGROUND ART

The expansion of commercial farming of aquatic species of fish and crustaceans has seen continued research into methods and apparatus for dispensing food. In recent years there has been a general replacement of live foods with formulated feeds. This has occurred primarily because the nutritional requirements of aquatic animals have been experimentally determined and it has been possible to formulate feeds as required.

Formulate feeds for the early stages of fish are typically provided in the form of micro-particulate food material that remains soluble in the aquaculture system for a sufficient period of time, and is of a size which allows for the food material to be readily consumed.

The manner in which the micro-particulate food material is dispensed provides several problems each of which relate to how, when and in what form the material is presented. Generally, the success of a particular feeding regime is measured in terms of the growth and survival rate of the aquatic animals. The manual effort required in maintaining and monitoring the aquaculture system is also a relevant factor.

Quantitative requirements including the water temperature, water depth, food type, food particle size, feeding frequency and so on, each have an effect on the growth and survival rate of the animals being reared.

Advantageous conditions for the growth, especially for fish and crustacean larvae, remains an area of continued research in which the feeding regime is of particular importance.

It would be of benefit if it were possible to experiment with several micro-particulate feeding regimes and to determine several advantageous methods of presenting the food material for subsequent consumption. It would also be advantageous if feeding regimes could be performed with control and reliability.

It is against this background and the problems and deficiencies associated therewith that the present invention has been developed.

### DISCLOSURE OF THE INVENTION

According to a first aspect of the invention there is provided a food dispenser for delivering an amount food material in particulate or powdered form comprising: a receptacle for holding the food material; and shutter means located at a lower end of the receptacle, the shutter means being moveable between an open position and a closed position; wherein upon movement from the closed position to the open position there is provided a passageway from the receptacle past the shutter means for delivery of the food material therethrough.

Preferably, the shutter means comprises at least two plates arranged for relative slidable movement between the closed and open positions, the two plates having a plurality of apertures which when in the closed position are not aligned (comment: they are aligned in a closed position) and which when in the open position are aligned so as to provide the passageway.

Preferably, the receptacle comprises a tube extending upwardly from the shutter means such that food material container in the tube can gravity feed past the shutter means.

Preferably, the food dispenser includes mounting means configured for mounting the food dispenser to a structure with the tube extending upwardly from the shutter means at angle inclined away from vertical. The food material may rest loosely in the tube along a lower side thereof. The angle from vertical may between 30 and 60 degrees from vertical. By reducing the amount of food material directly above the shutter compaction is reduced preventing the formation of a plug of compressed feed.

Preferably, the food dispenser includes a dispersion means for dispersing the food material over an area, once the food has passed through the passageway. The dispersion means may comprise an air flow delivery means arranged beneath the shutter means for blowing the food material over the area.

The mounting means may be configured for allowing the receptacle to shake upon movement of the shutter means. This may loosen the food material to avoid compaction of the food material above the shutter means.

The food dispenser may include an actuator for repetitively moving the shutter means between the open and closed positions. The food dispenser may include a controller coupled to the actuator for moving the shutter means according to predetermined criteria so as to controllably deliver the food material. Preferably, repetitively moving the shutter means causes vibrations which are transmitted to and shake the receptacle.

According to a second aspect of the invention there is provided a method of dispensing food material in particulate or powdered form including: holding the food material in a receptacle; moving a shutter means from a closed position to an open position to provide a passageway through which the food material can pass from the receptacle; allowing the food material to pass through the passageway; and moving the shutter means from the open position to the closed position to stop the passage of the food material.

Preferably, the method includes shaking the receptacle by having the receptacle mounted to a structure such that vibrations associated with moving the shutter means travel to the receptacle and loosen the food material.

Preferably, the method includes dispersing the food material over an area once the food material has passed through the passageway. Preferably, dispersing the food material includes subjecting the food material to an airflow.

Preferably, the method includes aligning a plurality of holes in the shutter means to provide the passageway and allow for the food material to pass therethrough.

Insight into the advantages and characteristics of the present invention can be gained from the following description of preferred embodiments and the accompanying drawings. Further aspects and preferred features may be apparent.

### BRIEF DESCRIPTION OF THE DRAWINGS

The invention will be better understood by reference to the following description of one specific embodiments thereof, as shown in the accompanying drawings in which:

FIG. 1 is a cross-sectional view in elevation of a food dispenser according to the embodiment of the invention;

FIG. 2 is an enlarged cross-sectional view in elevation of the food disperser in use;

FIG. 3 is a fragmentary elevational view of the food dispenser in an open condition for dispensing food;

FIG. 4 is a fragmentary elevational view of the food dispenser in a first (normal) closed condition;

FIG. 5 is a fragmentary elevational view of the food dispenser in a second closed condition, momentarily interrupting dispensing of food;

FIG. 6 is plan view of an upper plate constituting a first component of shutter means used in the food dispenser;

FIG. 7 is a plan view of a lower plate constituting a second component of the shutter means used in the food dispenser;

FIG. 8 is a side view in elevation of a body constituting part of the food dispenser;

FIG. 9 is a plan view of the body;

FIG. 10 is rear view of the body; and

FIG. 11 is a front cross sectional view of the body taken along the plane designated 11-11 in FIG. 8;

### BEST MODE(S) FOR CARRYING OUT THE INVENTION

Referring to the drawings there is shown a food dispenser 10 according to a preferred embodiment of the invention. The food dispenser 10 is configured for periodically administering a controlled micro-diet to a larvae culture tank. The micro-diet comprises formulated feed.

The food dispenser 10 includes a receptacle 12 for holding the formulated feed. A number of commercial feed types may be held in the receptacle 12 including Gemma Micro 150 and 300; Gemma 0.3, Skretting crumble 600 and 1 mm [Skretting]; Proton 1, 2/4 and 3/5; NRD 3/5, 4/6 and 5/8 [Inve].

A shutter means 14 is located at a lower end of the receptacle 12 and is moveable between an open position and a closed position. Upon movement from the closed position to the open position, the shutter means 14 provides a passageway 16 from the receptacle 12 past the shutter means 14 for the passage and delivery of the feed.

A control interface means 18 is provided such that the food dispenser 10 can be coupled to a programmable logic controller which is able to spread the allocation of micro-particulate feed across the whole day. This prevents the need to manually feed the larvae, and provides a more constant availability of the feed across the whole photoperiod. This reduces the opportunity for bacterial proliferation because of unconsumed feed which can spoil the aquaculture system.

The shutter means 14 comprises an upper plate 20 and a lower plate 22 which are arranged for relative slidable movement between the closed and open positions. More particularly, the upper plate 20 is movable (and hence is the active plate) and the lower plate 22 is fixed (and hence is the inactive plate).

Each the plates 20 and 22 include a plurality of apertures 24 which when in the closed position are not aligned and which when in the open position are aligned so as to provide the passageway 16. In this embodiment the passageway 16 comprises two channels 28.

The upper and lower plates 20 and 22 interact loosely for a loose action therebetween in order to stop shear compression of the feed as it passes therethrough. Shear action on the feed causes the feed to compact at the end of the receptacle 12 between the plates 20, 22 which would otherwise block the feeder 10.

The shutter means 14 further includes a piston solenoid 30 having actuation arm 40 which is connected to the upper plate 20 through a hole using pin 21. By moving the solenoid 30, the upper plate 20 can be pulled across the bottom of the receptacle 12. Typically, the solenoid 30 is a low voltage solenoid, such as 12 or 24 volts DC.

The receptacle 12 comprises a conduit defining a tube 31 which can contain the feed and which is made from transparent material allowing for the quantity of remaining feed to be readily viewed. In this embodiment, the tube 31 comprises a

PVC tube of 25 mm internal diameter. Other tubes with different dimensions can be fitted. The tube is closed at its upper end by a removable closure configured as a cap 37.

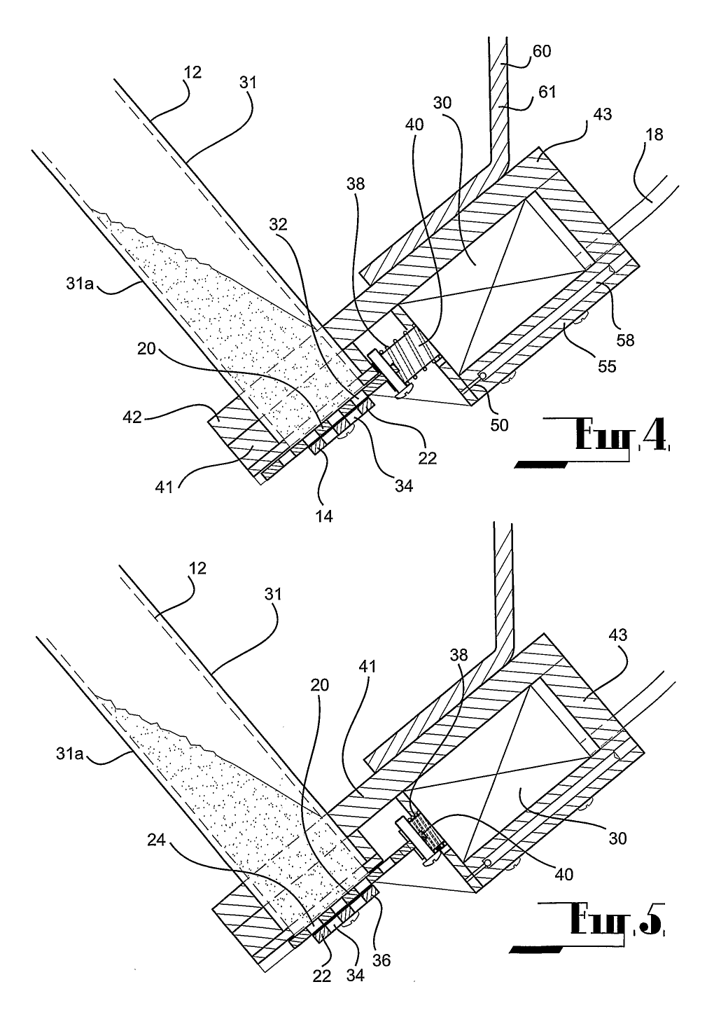

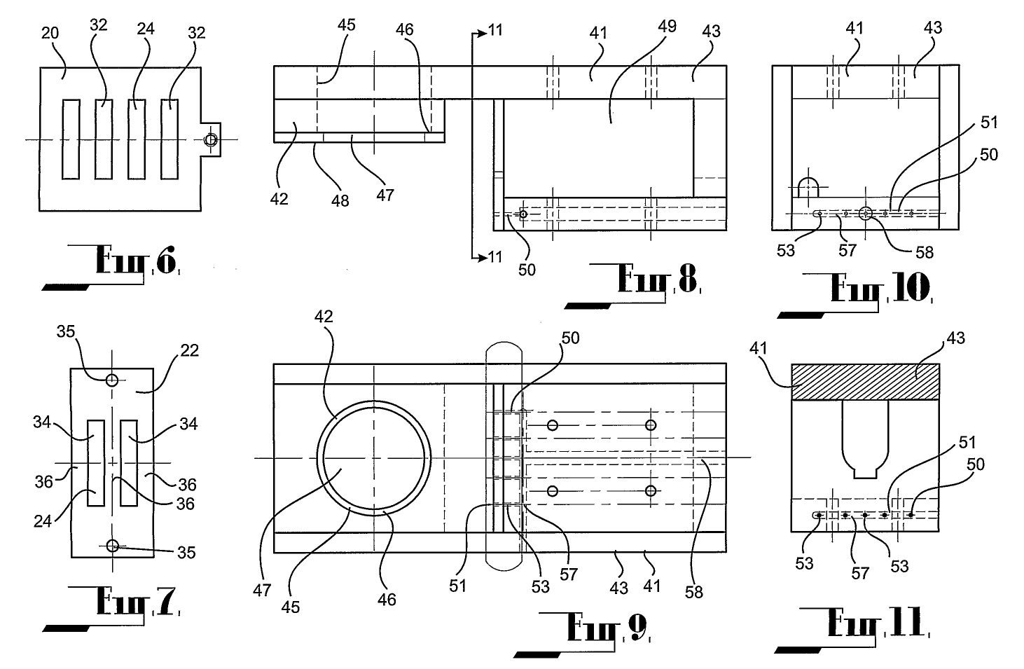

FIG. 6 shows the upper plate 20 in plan. The upper plate 20 provides the plurality of apertures 24 therein as four rectangular slots 32 each of 5 mm in width in this embodiment. FIG. 7 shows the lower plate 22 in plan. The lower plate 22 provides the plurality of apertures 24 therein as two rectangular slots 34 although in other embodiments it may include four to match the upper plate 20. The lower plate 22 also provides bars 36 adjacent the slots 34. Having four slots instead of two would increase the amount of micro-particulate material delivered in one oscillation from the closed position to the open position and back to the closed position. No it wouldn't. You could add one extra slot to the existing base plate, increase the tube aperture and get more food, without modifying the top plate. To have anymore than three slots in the base plate would require additional slots in the top plate.

The lower plate 22 includes two mounting holes 35 which allow for the lower plate 22 to be readily changed as required.

When the shutter means 14 is in a closed position, the slots 32 of the upper plate 20 overlap with bars 36 on the lower plate 22, thus preventing the feed from falling therethrough. In operation, the upper plate 20 is moved by the solenoid 30 between the bottom of the feed tube 31 and the lower plate 22. As a whole the shutter means moves between open and closed positions.

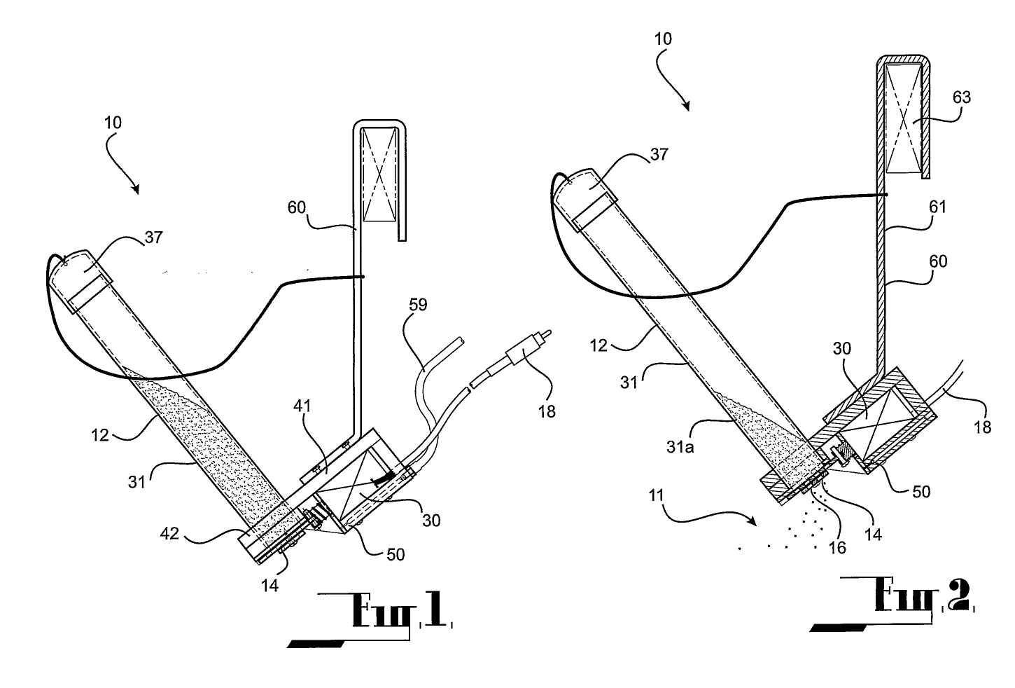

A spring 38 (not very visible in drawings)disposed around the actuation arm 40 of the solenoid 30 biases the actuation arm towards the outermost condition. In this way, the upper plate 20 is so biased that the shutter 12 is normally in the closed position, as shown in FIGS. 1 and 4. The extent of outward movement of the actuation arm 40 is limited by abutment with the body 41, as best seen in FIG. 4. When the solenoid 30 moves the actuation arm 40 to pull the upper plate 20, the slots 32 therein align with the slots 34 of the lower plate providing the two channels 28. In this embodiment is spring 38 is made of stainless steel.

As noted the receptacle 12 comprises the tube 31 or conduit 20 that extends upwardly from the shutter means 14. In this manner, when the receptacle 12 is filled with the feed, the portion of the feed at the lower end of the receptacle 12 has a further portion of feed thereabove. Thus when the two channels 28 are provided by moving the upper plate 20 the feed material moves past the shutter means 14 with the assistance of its own weight; that is, the feed is gravity fed to the shutter means 14.

The shutter means 14 can be moved multiple times in any one feeding event. The number of times is predetermined according to the particular flow characteristics of the particular feed and the total amount required of feed required during a feeding event. The plurality of apertures and the control of the piston allows precise repetitive allocation of the feed amount per feed event.

The dispenser 10 includes a body 41 which provides a frame to support the plates 20 and 22, the tube 31 and the solenoid 30. The body 41 includes a portion 42 incorporating a socket 45 into which the tube 31 can be received at the lower end thereof. The socket 45 has an annular lip 46 at its inner end against which the lower end of the tube 31 locates The annular lip 46 defines an opening 47 which corresponds to the interior of the tube 31. The portion 42 has a lower face 48 below which the upper plate 20 slides. The lower plate 22 is fixed with respect to the body 41 and is releasably attached thereto by fasteners such as screws 23 inserted in the mounting holes 35. The spacing between the mounting holes 35 is such that the upper plate 20 can be accommodated between the screws 23 without being impeded thereby.

The body 41 also includes a portion 43 defining a cavity 49 which houses the solenoid 30.

A dispersing unit 50 for dispersing the feed over an area, once the feed has passed through the shutter means 14, is provided at a lower end of the frame 42. The dispersing unit 50 includes an air flow delivery means 51 arranged to delivery an air stream beneath the shutter means 14 for blowing the food material. The air flow delivery means 51 comprises a plurality of outlets 53 formed in a bottom wall 55 of the portion 43 of the body 41. The outlets 53 provide a relatively consistent air flow for dispersing and breaking up the feed. The outlets 53 communicate with a manifold 57 incorporated within the bottom wall 55. The manifold 57 receives air for supply to the outlets 53 from a flow path 58 which is incorporated in bottom wall 55 and which is coupled to a source of pressurised air (not shown) by an air supply line 59.

A programmable logic controller (PLC) is connected to the food dispenser 10 via the control interface means 18. In this embodiment, the logic controller includes a power source operating at 100 to 240 Volts AC with 10 Amps (not that important but the same Mitsubishi Alpha is also available in 24 V DC). The PLC includes a plurality of relays for a corresponding number of food dispensers each equivalent to food dispenser 10. The relays and provide a 12 Volt DC power supply and are rated at 24 to 48 Watts in this embodiment.

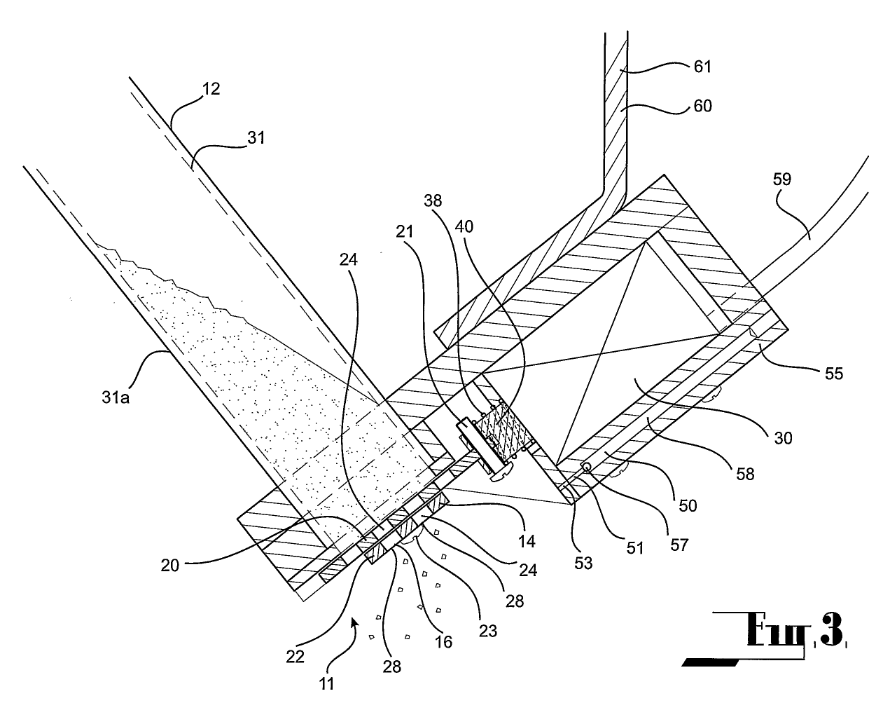

The food dispenser 10 is installed above the water surface of an aquaculture tank and is spaced part from any aeration or air diffusers. A distance of about 200 mm above the water surface has been found to be appropriate. With this arrangement, the dispersing unit 50 provides a dispersion area on the water surface. The food dispenser 10 is directed towards the dispersion area with sufficient air pressure supplied to spread the feed fairly evenly over the dispersion area If the air pressure is insufficient the feed may clump and sink through the water column below the dispersion area too rapidly. The air pressure will vary with embodiments and can be generally optimized by routine trial. Micro-particulate feed particles 11 are shown being dispersed in FIGS. 2 and 3. The air outlets 50 serve to break up the feed.

It is also to be appreciated that the air supply should be dry so as to prevent the feed from clumping and sticking to the upper and lower plates 20, 22. If a wider dispersion area is required then the dispenser can be installed at a greater distance above the water surface of the aquaculture system. Alternatively the speed or volume of the airflow can increased or modified. The physical characteristics of the feed will determine the required amount.

The food dispenser 10 includes mounting means 60 provided in the form of a flexible bracket 61. The flexible bracket 61 is configured for mounting the food dispenser 10 to a beam 63 such that the elongate tube 31 extends upwardly from the shutter means 14 at angle inclined away from vertical. In this arrangement the bracket 61 is designed to hold the tube 31 at angle included at about 45° away from vertical. The configuration of the flexible bracket 61 ensures that the receptacle 12 is allowed to shake upon movement of the shutter means 14 deliver the feed. This has been seen to advantageously prevent the accumulation of feed in the workings of the shutter means 14. Thus while the upper plate 20 moves back and forth a number of times to deliver a quantity of feed in a feed event, vibrations associated therewith, from the solenoid 30 or plates 20 and 22, or otherwise, are transmitted to the tube 31 This is prevents the feed from being compacted on the upper plate 20 and allows a more uniform distribution and allocation of feed during of the feeding period.

Advantageously, the feed rests loosely in the tube 31 along an inside lower side 31a, as shown in the drawings. By its angular disposition the feed is prevented from compacting on the upper plate 20.

In addition to the commercial feed types mentioned above a number of experimental feed types have been passed successfully through the feeder 10. These were made by oven drying extruded pellets. The pellets were then ground and sieved to suitable particle size ranges. Particle size ranges included, 100-300 μm, 300-500 μm, 500-780 μm, 780 μm-1.0 mm and 1.0-1.5 mm. Other sizes may of course be suitable. To assist with maximizing performance compacting on the upper plate 20 should be avoided.

The programmable logic controller is factory set with a periodic feeding program for a particular fish larvae species, the feeding program providing a predetermined feeding regime. The time between feeding events can be readily changed using a personal computer software interface.

It may be desirable to stop all the feeders from operating at one time at the start of each feeding period. For this purpose an onblock delay routine is provided.

The number of upper plate 20 oscillations per feeding event may be adjusted to vary and control the amount of feed delivered to an aquaculture tank over a feed event.

The amount of feed delivered per feed event, (i.e. the aliquot size), will inherently depend on the feed flow characteristics, which are known to vary with the particle size, the constituents of the feed and so on. Despite this the controller is able to control the feeder 10 via the control interface 18 such that the aliquot size can be substantially predetermined.

Generally, when the upper plate moves over a single oscillation during a feeding event, that is when the shutter 14 moves from the closed position to the open position and back to the open position, the feed will flow through from the receptacle 12 at a relatively slow rate. A single oscillation is generally appropriate for diets that have relatively fast flow characteristics, such as Proton 2/4 or Gemma 0.3. If a double or multiple-action feeding program is used with these feeds then although they will flow quite freely through the shutter means 14 over feeding may result if the solenoid is not operated quickly.

A double oscillation per feeding event is generally necessary when delivering Gemma Micro 150 to the larvae culture tanks. In one arrangement Gemma Micro 150 is delivered at a rate of 0.025 g per feeding event using a double plate action.

With Gemma Micro 150 and some smaller experimental feeds the shaking action on the conduit has been seen to be most advantageous. The shaking has been seen to shake the feed loose back up the tube 31 and then allow for the feed to naturally fall back into place, it has been seen that vibration on the first action to shake the feed down can result in more than twice the aliquot being delivered. If larger amounts are needed per feeding event, more plate actions can be used. Also the number of slots can varied coupled with the conduit 12 aperture being increased. The feeder program will need to be calibrated to individual feeds, with their flow characteristics in mind.

Some smaller particulate feeds have been seen to pass through the dispenser 10 in smaller aliquots than larger feeds. This is thought to arise because the higher surface area of the smaller particulate feeds creates a higher coefficient of friction that results in slower flow characteristics. By measuring the amount of feed in the tube 31 the amount of feed delivered per feeding cycle can be accurately predetermined. This enables the PLC to be programmed to deliver the right amount of feed within the correct time frame.

The method of operation is relatively simple. The tube 31 is opened at its upper end by removal of cap 37 and the feed gently allowed to fall down the feed tube and onto the upper feeder plate 20 such that the feed is not compacted. The use of a funnel is recommended to avoid spillage. After this the PLC is used to set the feed events by specifying a specific date and time. It is possible to set the duration or number of cycles per feeding event.

The PLC can be programmed to deliver a few larger doses at prescribed times, for example 3 morning feeding events at 15 min intervals and 3 afternoon feeding events at 20 min intervals. Typically the solenoid 30 is operated for 0.3 seconds “on” and 0.1 seconds “off” for multiple action, during any one feeding oscillation. This moves the shutter means 14 to the open position and allows the spring 38 to move the shutter means 14 back to the closed position. Multiple oscillations are performed when larger amounts of feed are required at any one time. In one arrangement feed events may occur every 10 minutes and deliver 0.2 milligrams of feed per event.

In addition to energising the solenoid 30 for fractions of a second to accurately control the amount of feed per feeding event the PLC has the facility to supply adjunct lighting and system maintenance equipment which allows for the complete synchronisation of the aquaculture system as a whole.

Thus the dispenser 10 dispenses the feed by first holding the feed in the receptacle 12. Then the passageway 26 is provided through which the food material can pass from the receptacle 12. This is performed by moving the shutter means 14 from the closed position to the open position. The feed then passes through the passageway 16 and is dispersed over an area. After the cycle the shutter means is moved from the open position to the closed position to stop the passage of the food material. After many cycles the dispenser 10 can be readily cleaned ensure reliable operation. This can be done with a high-pressure air nozzle.

It will be understood that various changes may be made to the form, details, arrangement and proportion of the various parts and steps without departing from the spirit and scope of the invention. For example the feed may be powdered. The mounting means may be hung from a cord connected to a beam. The lower plate be connected to the solenoid and the upper plate held stationary. The feeder may be used in a marine hatchery environment. Modifications and variations such as would be apparent to the skilled addressee are, at the very least, considered to fall within the scope of the present invention, of which the preferred embodiment described herein is one specific example.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A food dispenser for delivering an amount of food material in particulate or powdered form comprising: a receptacle for holding the food material; and a shutter means located at a lower end of the receptacle, the shutter means being movable between an open position and a closed position; wherein upon movement from the closed position to the open position there is provided a passageway from the receptacle past the shutter means for delivery of the food material therethrough; the receptacle comprising a conduit having a longitudinal axis inclined away from vertical when in use.

2. The food dispenser of claim 1 wherein the conduit comprises a tube.

3. The food dispenser of claim 2 wherein the shutter means is located at the lower end of the tube.

4. The food dispenser of claim 1 wherein the shutter means comprises at least two plates arranged for relative slidable movement between the closed and open positions, the two plates having a plurality of apertures which when in the closed position are not aligned and which when in the open position are aligned so as to provide the passageway.

5. (canceled)

6. The food dispenser of claim 2 further comprising mounting means configured for mounting the food dispenser to a structure with the tube extending upwardly from the shutter means at angle inclined away from vertical.

7. The food dispenser of claim 1 further comprising a dispersion means for dispersing the food material over an area, once the food has passed through the passageway.

8. The food dispenser according to claim 7 wherein the dispersion means comprises an air flow delivery means arranged beneath the shutter means for blowing the food material over the area.

9. The food dispenser of claim 7 wherein mounting means is configured for allowing the receptacle to shake upon movement of the shutter means.

10. The food dispenser of claim 1 further comprising an actuator for repetitively moving the shutter means between the open and closed positions.

11. The food dispenser of claim 10 further comprising a controller coupled to the actuator for moving the shutter means according to predetermined criteria so as to controllably deliver the food material.

12. A method of dispensing food material in particulate or powdered form including: holding the food material in a receptacle having a longitudinal axis inclined away from vertical; moving a shutter means from a closed position to an open position to provide a passageway through which the food material can pass from the receptacle; allowing the food material to pass through the passageway; and moving the shutter means from the open position to the closed position to stop the passage of the food material.

13. The method of claim 12 further including shaking the receptacle by having the receptacle mounted to a structure such that vibrations associated with moving the shutter means travel to the receptacle and loosen the food material.

14. The method of claim 12 further including dispersing the food material over an area once the food material has passed through the passageway.

15. The method of claim 14 wherein dispersing the food material includes subjecting the food material to an airflow.

16. The method according of claim 12 further including aligning a plurality of holes in the shutter means to provide the passageway and allow for the food material to pass therethrough.

17. A food dispenser for delivering an amount of food material in particulate or powdered form comprising: a receptacle for holding the food material; a shutter means located at a lower end of the receptacle, the shutter means being movable between an open position and a closed position, wherein upon movement from the closed position to the open position there is provided a passageway from the receptacle past the shutter means for delivery of the food material therethrough; and a dispersion means for dispersing delivered food material over an area, once the food has passed through the passageway, the dispersion means comprising an air flow delivery means arranged beneath the shutter means for blowing the food material over the area.

18-19. (canceled)
